(19) United States
(12) Patent Application Publication
(10) Pub. No.: US 2026/0094879 A1
(43) Pub. Date: Apr. 2, 2026

(54) METHOD AND APPARATUS FOR INSPECTING A POUCH BATTERY CELL FOR LIQUID LEAKAGE

(71) Applicant: SAMSUNG SDI CO., LTD., Yongin-si (KR)

(72) Inventor: Sac LEE, Yongin-si (KR)

(21) Appl. No.: 19/214,452

(22) Filed: May 21, 2025

(30) Foreign Application Priority Data
Sep. 27, 2024 (KR) 10-2024-0131762

(51) Int. Cl. H01M 10/42; H01M 10/48; H01M 50/105

(52) U.S. Cl. CPC H01M 10/4228; H01M 10/4285; H01M 10/488; H01M 50/105

(57) ABSTRACT

A method for inspecting a pouch battery cell for liquid leakage, the method including bringing a first electrolyte reaction sheet into contact with a top surface of the pouch battery cell, visually inspecting a change in a color of the first electrolyte reaction sheet, bringing a second electrolyte reaction sheet into contact with a bottom surface of the pouch battery cell, and visually inspecting a change in a color of the second electrolyte reaction sheet.

### CROSS-REFERENCE TO RELATED APPLICATION

This application claims priority to and the benefit of Korean Patent Application No. 10-2024-0131762, filed on Sep. 27, 2024, the disclosure of which is incorporated herein by reference in its entirety.

### BACKGROUND

### 1. Field

Embodiments of the present disclosure relate to a method and an apparatus for inspecting a pouch battery cell for liquid leakage.

### 2. Description of the Related Art

A pouch battery cell assembly process includes an electrolyte injection process. The electrolyte injection process is a process in which an electrolyte is injected and a vacuum chamber is performed before a pouch is sealed. When the electrolyte is injected and the vacuum chamber is performed, the electrolyte may be scattered outside a cell. In such a case, the scattered electrolyte may adhere to the pouch battery cell, causing cell appearance defects.

The above information disclosed in this Background section is for enhancement of understanding of the background of the present disclosure, and therefore, it may contain information that does not constitute a prior art.

### SUMMARY

Embodiments include a method for inspecting a pouch battery cell for liquid leakage, the method including bringing a first electrolyte reaction sheet into contact with a top surface of the pouch battery cell, visually inspecting a change in a color of the first electrolyte reaction sheet, bringing a second electrolyte reaction sheet into contact with a bottom surface of the pouch battery cell, and visually inspecting a change in a color of the second electrolyte reaction sheet.

Bringing a first electrolyte reaction sheet into contact with a top surface of the pouch battery cell may include introducing the pouch battery cell below a top surface inspection plate with a bottom surface to which the first electrolyte reaction sheet is attached, bringing the first electrolyte reaction sheet into contact with the top surface of the pouch battery cell may include lowering the top surface inspection plate, lifting the top surface inspection plate and rotating the top surface inspection plate by 180°, and inspecting, by a top surface vision inspection section placed above the top surface inspection plate, a change in the color of the first electrolyte reaction sheet.

The top surface inspection plate may be placed above a transport path, and the pouch battery cell may be below the top surface inspection plate along the transport path.

Bringing a second electrolyte reaction sheet into contact with a bottom surface of the pouch battery cell and visually inspecting a change in a color of the second electrolyte reaction sheet may include picking up, by a cell moving section, the pouch battery cell to bring the bottom surface of the pouch battery cell into contact with the second electrolyte reaction sheet placed on a bottom surface inspection plate, the cell moving section returning the pouch battery cell to an original position, and inspecting, by a bottom surface vision inspection section placed above the bottom surface inspection plate, a change in the color of the second electrolyte reaction sheet.

The pouch battery cell may be transported along the transport path, the cell moving section may be placed on one side of the transport path, and the bottom surface inspection plate may be placed on an opposite side of the transport path.

The picking up may include picking up, by the cell moving section, the pouch battery cell with a vacuum grip, the cell moving section moving the pouch battery cell above the bottom surface inspection plate, moving, by the cell moving section, the vacuum grip downward to bring the bottom surface of the pouch battery cell into contact with the second electrolyte reaction sheet attached on the bottom surface inspection plate, moving, by the cell moving section, the vacuum grip to an original position, and placing, by the cell moving section using the vacuum grip, the pouch battery cell on the transport path.

Bringing the first electrolyte reaction sheet into contact with the top surface of the pouch battery cell and visually inspecting a change in a color of the first electrolyte reaction sheet may be simultaneously performed on a plurality of pouch battery cells, and bringing the second electrolyte reaction sheet into contact with the bottom surface of the pouch battery cell and visually inspecting a change in a color of the second electrolyte reaction sheet may be simultaneously performed on the plurality of pouch battery cells.

Embodiments include an apparatus for inspecting a pouch battery cell for liquid leakage, the apparatus including a top surface inspection unit configured to bring a first electrolyte reaction sheet into contact with a top surface of a pouch battery cell and visually inspects a change in a color of the first electrolyte reaction sheet, and a bottom surface inspection unit configured to bring a second electrolyte reaction sheet into contact with a bottom surface of the pouch battery cell and visually inspects a change in a color of the second electrolyte reaction sheet.

The top surface inspection unit may include a top surface inspection plate with a bottom surface to which the first electrolyte reaction sheet is attached, the top surface inspection plate may be rotatable 180° and may be able to move up and down, and a top surface vision inspection section may be above the top surface inspection plate to visually inspect a change in the color of the first electrolyte reaction sheet.

The top surface inspection plate may be above a transport path, and the pouch battery cell may be below the top surface inspection plate along the transport path.

The bottom surface inspection unit may include a bottom surface inspection plate with a top surface to which the second electrolyte reaction sheet is attached, a bottom surface vision inspection section may be above the bottom surface inspection plate, the bottom surface vision inspection section may visually inspect a change in the color of the second electrolyte reaction sheet, and a cell moving section may move the pouch battery cell to the bottom surface inspection plate to bring the bottom surface of the pouch battery cell into contact with the second electrolyte reaction sheet, and the cell moving section may return the pouch battery cell to an original position.

The pouch battery cell may be along the transport path, the cell moving section may be on one side of the transport path, and the bottom surface inspection plate may be on an opposite side of the transport path.

The cell moving section may include a vacuum grip for holding the pouch battery cell, and a mover for moving the vacuum grip over the bottom surface inspection plate.

The apparatus for inspecting a pouch battery cell for liquid leakage may further include a first support on a first side of the transport path to support the top surface vision inspection section, and a second support on a second side of the transport path to support the bottom surface vision inspection section.

The top surface inspection unit may include a plurality of top surface inspection plates and a plurality of top surface vision inspection sections to simultaneously inspect the top surface on a plurality of pouch battery cells, and the bottom surface inspection unit may include a plurality of bottom surface inspection plates and a plurality of bottom surface vision inspection sections to simultaneously inspect the bottom surface on the plurality of pouch battery cells.

Aspects and features of the present disclosure are not limited to those described above, and other aspects and features not specifically mentioned herein will be clearly understood by those skilled in the art from the description of the present disclosure below.

### BRIEF DESCRIPTION OF THE DRAWINGS

Features will become apparent to those of ordinary skill in the art by describing in detail exemplary embodiments with reference to the attached drawings, in which:

FIG. 1 is a partial exploded perspective view of a pouch-type battery;

FIG. 2 is a functional block diagram illustrating the configuration of an apparatus for inspecting a pouch battery cell for liquid leakage according to an embodiment of the present disclosure;

FIG. 3 is a flowchart showing an operation flow of a method for inspecting a pouch battery cell for liquid leakage according to an embodiment of the present disclosure;

FIGS. 4A to 4D are explanatory diagrams for explaining a top surface inspection procedure according to an embodiment of the present disclosure;

FIGS. 5A to 5C are explanatory diagrams for explaining a bottom surface inspection procedure according to an embodiment of the present disclosure;

FIG. 6 is a schematic diagram illustrating the configuration of an apparatus for inspecting a pouch battery cell for liquid leakage according to an embodiment of the present disclosure;

FIG. 7 illustrates the arrangement of a top surface inspection unit and a bottom surface inspection unit of an apparatus for inspecting a pouch battery cell for liquid leakage according to an embodiment of the present disclosure;

FIG. 8 illustrates an inspection plate driving section according to an embodiment of the present disclosure; and

FIG. 9 illustrates a cell moving section and a bottom surface inspection plate of a bottom surface inspection unit according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own embodiments in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

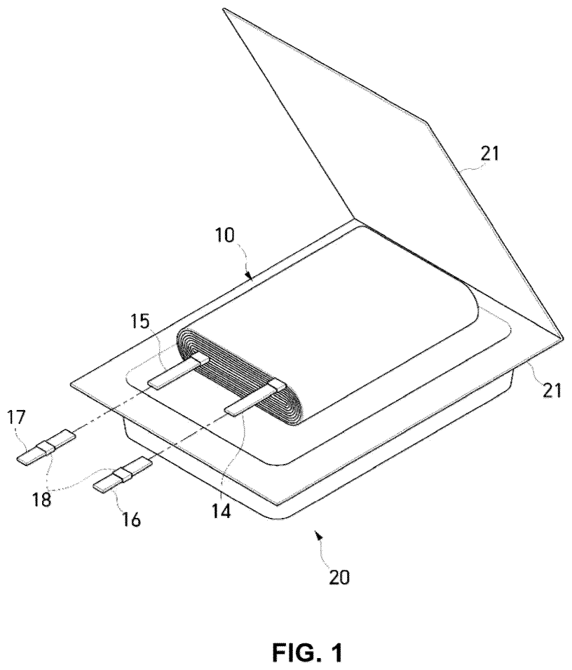

FIG. 1 is a partial exploded perspective view of a pouch-type secondary battery.

The pouch-type secondary battery includes an electrode assembly 10 and a pouch 20 accommodating the electrode assembly 10.

A first electrode tab 14 and a second electrode tab 15 as shown in FIG. 1 are respectively welded to a first electrode lead 16 and a second electrode lead 17, respectively, of an external terminal to be electrically connected to the outside. A tab film 18 for insulation from the pouch 20 is attached to the first electrode lead 16 and the second electrode lead 17.

In a state in which the electrode assembly 10 is accommodated in the pouch 20, sealing parts 21 of edges of the pouch 20 come into contact with each other to be sealed. The sealing is performed in a state in which the tab film 18 is disposed between the sealing parts 21. The sealing parts 21 at the bottom portion of the pouch 20 as well as the top portion may be made of a heat-fusible material and may have a structure in which sealing may be achieved by bonding heat-fusible layers to each other. Because the heat-fusible material generally has weak adhesion to metal, the tab film 18 may be in the form of a thin film attached to a tab to be fused to the pouch 20.

In the present disclosure, an electrolyte reaction sheet is used to inspect a pouch cell (e.g., pouch battery cell) for liquid leakage. In a case in which a pouch battery cell is brought into contact with the electrolyte reaction sheet, when there is a leaked liquid on the pouch battery cell, the electrolyte reaction sheet reacts with the leaked liquid, so that a color of the electrolyte reaction sheet is changed. The presence or absence of a liquid leakage in the pouch battery cell may be detected by performing a vision inspection on a change in the color of the electrolyte reaction sheet. In the present disclosure, both top and bottom surfaces of the pouch battery cell are brought into contact with the electrolyte reaction sheet and a vision inspection is performed. The top and bottom surface inspections may be sequentially performed while transporting the pouch battery cell along a transport path.

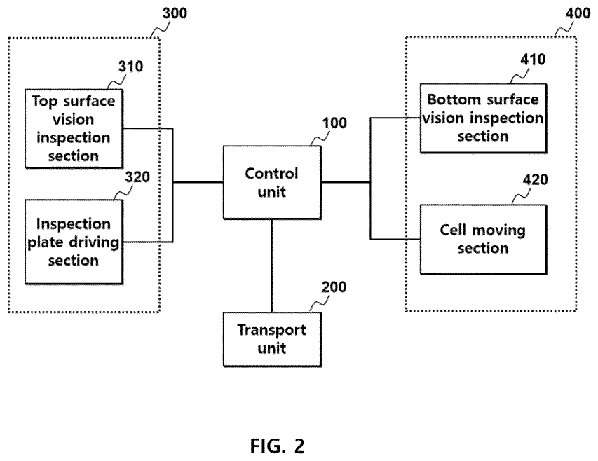

FIG. 2 is a functional block diagram illustrating the configuration of an apparatus for inspecting a pouch battery cell for liquid leakage according to an embodiment of the present disclosure.

The apparatus for inspecting a pouch battery cell for liquid leakage of the present disclosure includes a top surface inspection unit 300 for inspecting the top surface of the pouch battery cell and a bottom surface inspection unit 400 for inspecting the bottom surface of the pouch battery cell. A transport unit 200 transports the pouch battery cell to the top surface inspection unit and the bottom surface inspection unit.

The top surface inspection unit 300 includes a top surface vision inspection section 310 for performing a vision inspection on an electrolyte reaction sheet and an inspection plate driving section 320 for driving an inspection plate on which the electrolyte reaction sheet is placed. The bottom surface inspection unit 400 includes a bottom surface vision inspection section 410 for performing a vision inspection on the electrolyte reaction sheet and a cell moving section 420 for moving the pouch battery cell to an inspection plate on which an electrolyte reaction sheet is placed and bringing the pouch battery cell into contact with the electrolyte reaction sheet.

A control unit 100 drives the transport unit 200 to transport the pouch battery cell to the top surface inspection unit 300 and the bottom surface inspection unit 400, and controls the top surface inspection unit 300 and the bottom surface inspection unit 400 to inspect the top surface and the bottom surface of the pouch battery cell, respectively.

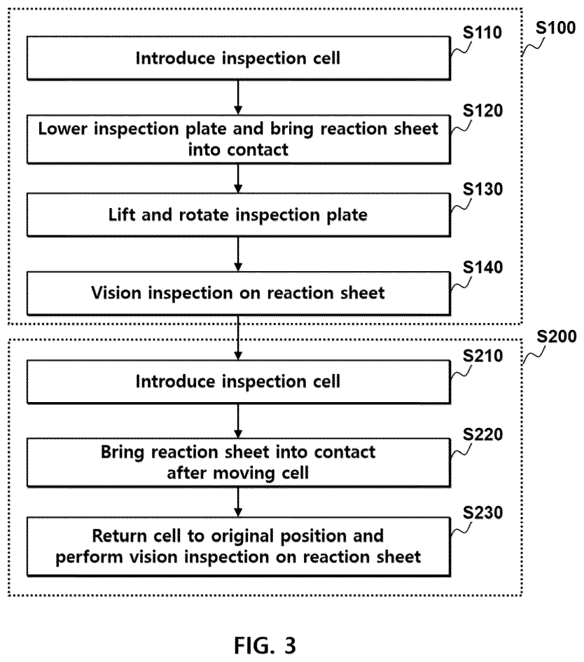

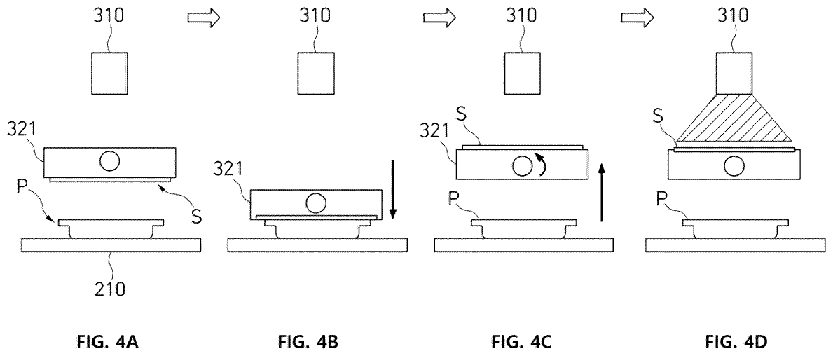

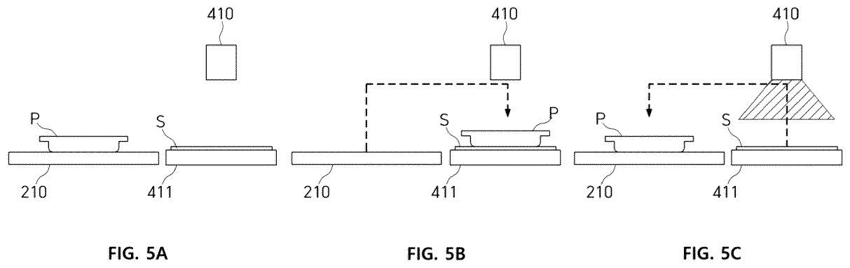

FIG. 3 is a flowchart showing an operation flow of a method for inspecting a pouch battery cell for liquid leakage according to an embodiment of the present disclosure, and FIGS. 4A-4D and 5A-5C are explanatory diagrams for explaining a top surface inspection procedure S100 and a bottom surface inspection procedure S200, respectively.

The control unit 100 introduces a pouch battery cell P to be inspected into the top surface inspection unit 300 along a transport path (step S110). The appearance at this time is illustrated in FIG. 4A. The pouch battery cell P is placed on a transport plate 210 and introduced below a top surface inspection plate 321 of the top surface inspection unit 300. An electrolyte reaction sheet S is attached to a bottom surface of the top surface inspection plate 321.

The control unit 100 lowers the top surface inspection plate 321 to bring the electrolyte reaction sheet S into contact with a top surface of the pouch battery cell P (step S120). The appearance at this time is illustrated in FIG. 4B.

The control unit 100 then lifts the top surface inspection plate 321 and rotates the top surface inspection plate 321 by 180° as illustrated in FIG. 4C (step S130). In other words, the top surface inspection plate is flipped bottom to top. Accordingly, the electrolyte reaction sheet S attached to the bottom surface of the top surface inspection plate 321 faces the top surface vision inspection section 310 after being rotated.

In such a state, the top surface vision inspection section 310 inspects a change in the color of the electrolyte reaction sheet S as illustrated in FIG. 4D (step S140). The top surface vision inspection section 310 transmits a vision inspection result (e.g., a signal indicating a vision inspection result) to the control unit 100, and when the vision inspection result indicates a liquid leakage, the control unit 100 checks (e.g., identifies) the pouch battery cell P as a defect.

When the inspection of the top surface is completed, the control unit 100 introduces the pouch battery cell P into a region of the bottom surface inspection unit 400 along the transport path (step S210). The appearance at this time is illustrated in FIG. 5A.

The cell moving section 420 picks up the introduced pouch battery cell P and brings the bottom surface of the pouch battery cell P into contact with an electrolyte reaction sheet S placed on a bottom surface inspection plate 411 arranged on a side of the transport path (step S220). The appearance at this time is illustrated in FIG. 5B.

After the bottom surface of the pouch battery cell P and the electrolyte reaction sheet S come into contact with each other, the cell moving section 420 returns the pouch battery cell P to its original position on the transport path. Then, as illustrated in FIG. 5C, the electrolyte reaction sheet S attached on the bottom surface inspection plate 411 faces the bottom surface vision inspection section 410. In such a state, the bottom surface vision inspection section 410 inspects a change in the color of the electrolyte reaction sheet S (step S230). The bottom surface vision inspection section 410 transmits a vision inspection result to the control unit 100, and when the vision inspection result indicates a liquid leakage, the control unit 100 checks (e.g., identifies) the pouch battery cell P as a defect.

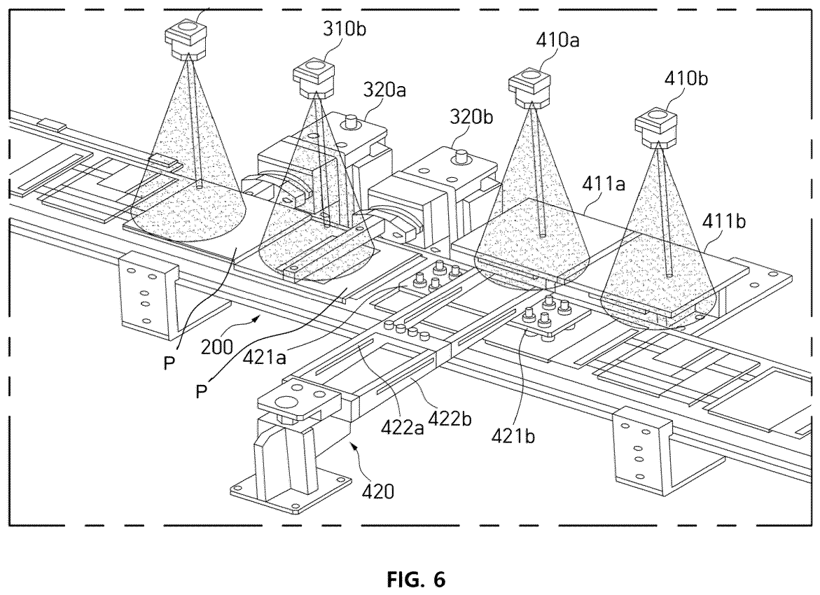

In some embodiments, a plurality of pouch battery cells may be configured to be simultaneously inspected. FIG. 6 is a schematic diagram illustrating the configuration of an apparatus for inspecting a pouch battery cell for liquid leakage according to an embodiment of the present disclosure. The embodiment of FIG. 6 shows an example of simultaneously performing a top surface inspection on two pouch battery cells and simultaneously performing a bottom surface inspection on the two pouch battery cells. To this end, in the embodiment of FIG. 6, two top surface vision inspection sections 310a and 310b and two bottom surface vision inspection sections 410a and 410b are provided. In the embodiment of FIG. 6, the transport unit 200 is formed as a straight conveyor and transports the pouch battery cell P along a transport path. In FIG. 6, the pouch battery cell P is transported from left to right. The top surface vision inspection sections 310a and 310b are positioned to vertically look down the transport path from directly above the transport path, and the bottom surface vision inspection sections 410a and 410b are positioned to vertically look down on bottom surface inspection plates 411a and 411b positioned on the side of the transport path.

When two pouch battery cells P are introduced below two top surface inspection plates of the top surface inspection unit 300, the inspection plate driving sections 320a and 320b lower the top surface inspection plates to bring electrolyte reaction sheets S into contact with top surfaces of the pouch battery cells P. Subsequently, the inspection plate driving sections 320a and 320b lift the top surface inspection plates and rotate the top surface inspection plates by 180° (e.g., flip bottom to top). Accordingly, the electrolyte reaction sheets S attached to the bottom surfaces of the top surface inspection plates face the top surface vision inspection sections 310a and 310b, and the top surface vision inspection sections 310a and 310b determine whether the electrolyte reaction sheets S have a color reaction.

For convenience of explanation, FIG. 6 illustrates the state in which the inspection plate driving section 320a on the left rotates the top surface inspection plate by 180° and the inspection plate driving section 320b on the right lowers the top surface inspection plate to bring the electrolyte reaction sheet S into contact with the top surface of the pouch battery cell P; however, in an actual operation, the two inspection plate driving sections 320a and 320b may be driven in synchronization with each other. That is, in FIG. 6, the inspection plate driving section 320a on the left rotates the top surface inspection plate by 180° so that the electrolyte reaction sheet S faces the top surface vision inspection section 310a, and the inspection plate driving section 320b on the right lowers the top surface inspection plate so that the electrolyte reaction sheet S is in contact with the top surface of the pouch battery cell P. However, the inspection plate driving sections 320a and 320b on the left and the right may perform the same operation at the same time.

The two pouch battery cells subjected to the top surface inspection are transported to the region of the bottom surface inspection unit 400 by the transport unit 200. In the embodiment of FIG. 6, the bottom surface inspection unit 400 includes the two bottom surface vision inspection sections 410a and 410b placed on the side of the transport path, and the cell moving section 420 placed on the opposite side of the transport path. Below the bottom surface vision inspection sections 410a and 410b, the bottom surface inspection plates 411a and 411b are placed. The electrolyte reaction sheet S is attached to the top surfaces of the bottom surface inspection plates 411a and 411b.

The cell moving section 420 includes two vacuum grips 421a and 421b for holding two pouch battery cells. The vacuum grips 421a and 421b are connected to two bridges 422a and 422b, respectively. In a state in which the vacuum grips 421a and 421b hold the pouch battery cells, respectively, the vacuum grips 421a and 421b are moved over the bottom surface inspection plates 411a and 411b. In some embodiments, the vacuum grips 421a and 421b may be configured to move along the bridges 422a and 422b, or the cell moving section 420 itself may be configured to move forward and backward in a direction perpendicular to the transport path so that the vacuum grips 421a and 421b move over the bottom surface inspection plates 411a and 411b.

In a state in which the vacuum grips 421a and 421b holding the pouch battery cells are placed over the bottom surface inspection plates 411a and 411b, the cell moving section 420 moves the vacuum grips 421a and 421b downward so that the bottom surfaces of the pouch battery cells come into contact with the electrolyte reaction sheets S attached on the bottom surface inspection plates 411a and 411b. After the contact, the cell moving section 420 moves the vacuum grips 421a and 421b to the original positions, and the vacuum grips 421a and 421b place the pouch battery cells back on the transport path.

In such a state, the electrolyte reaction sheets S attached to the top surfaces of the bottom surface inspection plates 411a and 411b face the bottom surface vision inspection sections 410a and 410b, and the bottom surface vision inspection sections 410a and 410b determine whether the electrolyte reaction sheets S have a color reaction.

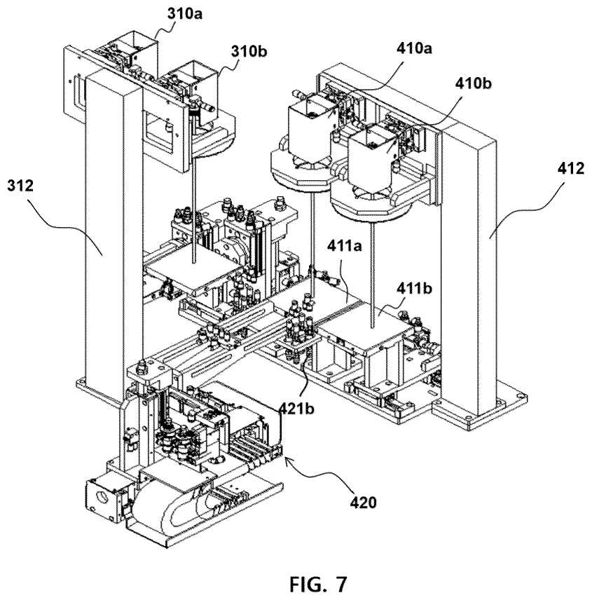

FIG. 7 illustrates the arrangement of the top surface inspection unit and the bottom surface inspection unit of the apparatus for inspecting a pouch battery cell for liquid leakage according to an embodiment of the present disclosure. FIG. 7 omits the transport unit 200 for convenience of illustration. FIG. 7 also illustrates a case in which a top surface inspection is performed on two pouch battery cells at the same time and a bottom surface inspection is performed on two pouch battery cells at the same time, similar to the embodiment of FIG. 6.

In FIG. 7, the two top surface vision inspection sections 310a and 310b are supported by one support 312 placed on one side of the transport path. Similarly, the two bottom surface vision inspection sections 410a and 410b are supported by one support 412 placed on one side of the transport path. The top surface vision inspection sections 310a and 310b are placed to vertically look down the top surface inspection plate from directly above the transport path, and the bottom surface vision inspection sections 410a and 410b are placed to vertically look down the bottom surface inspection plates 411a and 411b positioned on the side of the transport path.

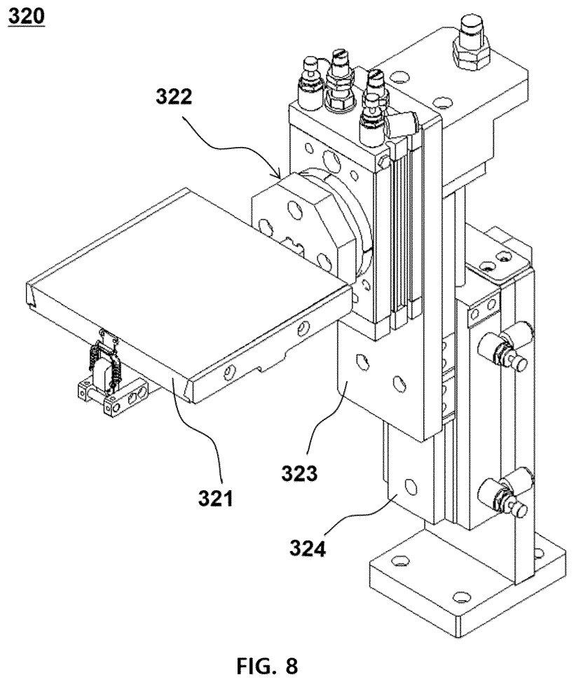

Since the top surface inspection plate 321 is connected to a rotation means (e.g., a rotator) 322 of the inspection plate driving section 320 as illustrated in FIG. 8, the top surface inspection plate 321 can rotate 180°. The rotation means 322 is connected to a movable plate 323, and the movable plate 323 moves up and down (e.g., up and down in the orientation shown in FIG. 8) along a movable rail 324. Accordingly, the top surface inspection plate 321 also moves up and down as the movable plate 323 moves up and down.

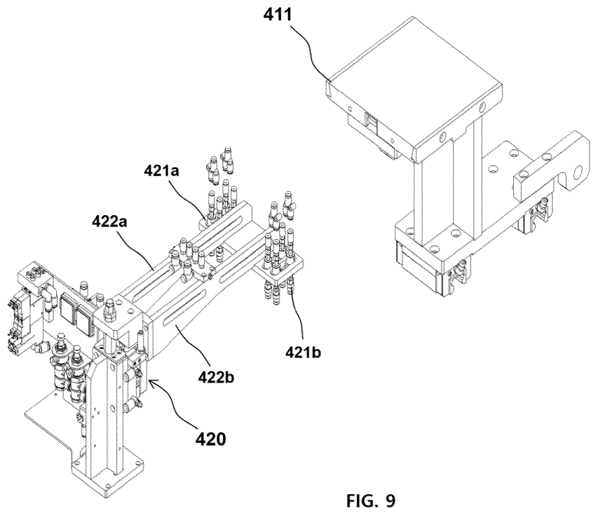

The cell moving section 420 of the bottom surface inspection unit includes two vacuum grips 421a and 421b for moving two pouch battery cells as illustrated in FIG. 9. The vacuum grips 421a and 421b are connected to two bridges 422a and 422b. The vacuum grips 421a and 421b pick up the pouch battery cells on the transport path, and the vacuum grips 421a and 421b are moved over the bottom surface inspection plates 411a and 411b along the bridges 422a and 422b while holding the pouch battery cells. FIG. 9 illustrates only one bottom surface inspection plate 411 for convenience of illustration.

The cell moving section 420 lowers the vacuum grips 421a and 421b moved over the bottom surface inspection plate 411 to bring the pouch battery cell into contact with an electrolyte reaction sheet.

In some embodiments, a bottom surface inspection plate lifting part may be provided to lift and lower the bottom surface inspection plate 411. In such a case, when the pouch battery cell is moved over the bottom surface inspection plate 411, the bottom surface inspection plate 411 is lifted by the bottom surface inspection plate lifting part to bring the electrolyte reaction sheet S into contact with the bottom surface of the pouch battery cell P.

In some embodiments, in order to move the pouch battery cell P over the bottom surface inspection plate 411, the cell moving section 420 itself may be moved forward with respect to the bottom surface inspection plate 411 so that the vacuum grips 421a and 421b move over the bottom surface inspection plate 411. After the pouch battery cell comes into contact with the electrolyte reaction sheet, the cell moving section 420 is moved backward with respect to the bottom surface inspection plate 411 so that the vacuum grips 421a and 421b are positioned above the transport path.

In order to determine whether cell appearance defects have occurred, a detection test is desirable. An operator may determine defects by visually inspecting a sample or measuring the weight of an amount of the electrolyte with a scale. However, the visual inspection has low precision and may not be able to detect defects in a cell other than the sample. In the case of the weight measurement inspection, there is a problem in that no defects are detected when the amount of the electrolyte attached to the cell surface is small (e.g., relatively small). In addition, since the weight measurement inspection is a method of measuring the entire weight of the pouch, it is not possible to determine defects when the electrolyte scattered inside the cell has been transferred to the surface.

According to the present disclosure, since a liquid leakage inspection is performed using an electrolyte reaction sheet, even when a small amount of electrolyte is attached to a cell surface, a defect can be detected.

According to the present disclosure, since both sides of a pouch can be inspected while transporting a pouch battery cell through a conveyor, the inspection efficiency is high.

According to the present disclosure, since a liquid leakage inspection is performed using an electrolyte reaction sheet, even when an electrolyte scattered inside has been transferred to a surface, a defect can be determined.

Although the present disclosure has been described above with respect to embodiments thereof, the present disclosure is not limited thereto. Various modifications and variations can be made by those skilled in the art within the spirit of the present disclosure and the scope of equivalence of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for inspecting a pouch battery cell for liquid leakage, the method comprising:
bringing a first electrolyte reaction sheet into contact with a top surface of the pouch battery cell;
visually inspecting a change in a color of the first electrolyte reaction sheet;
bringing a second electrolyte reaction sheet into contact with a bottom surface of the pouch battery cell; and
visually inspecting a change in a color of the second electrolyte reaction sheet.

2. The method for inspecting a pouch battery cell for liquid leakage as claimed in claim 1, wherein bringing the first electrolyte reaction sheet into contact with the top surface of the pouch battery cell comprises:
introducing the pouch battery cell below a top surface inspection plate with a bottom surface to which the first electrolyte reaction sheet is attached;
bringing the first electrolyte reaction sheet into contact with the top surface of the pouch battery cell by lowering the top surface inspection plate;
lifting the top surface inspection plate and rotating the top surface inspection plate by 180°; and
inspecting, by a top surface vision inspection section placed above the top surface inspection plate, a change in the color of the first electrolyte reaction sheet.

3. The method for inspecting a pouch battery cell for liquid leakage as claimed in claim 2, wherein:
the top surface inspection plate is placed above a transport path, and
the pouch battery cell is introduced below the top surface inspection plate along the transport path.

4. The method for inspecting a pouch battery cell for liquid leakage as claimed in claim 3, wherein bringing a second electrolyte reaction sheet into contact with a bottom surface of the pouch battery cell and visually inspecting a change in a color of the second electrolyte reaction sheet comprises:
picking up, by a cell moving section, the pouch battery cell to bring the bottom surface of the pouch battery cell into contact with the second electrolyte reaction sheet placed on a bottom surface inspection plate, the cell moving section returning the pouch battery cell to an original position; and
inspecting, by a bottom surface vision inspection section placed above the bottom surface inspection plate, a change in the color of the second electrolyte reaction sheet.

5. The method for inspecting a pouch battery cell for liquid leakage as claimed in claim 4, wherein:
the pouch battery cell is transported along the transport path,
the cell moving section is placed on one side of the transport path, and
the bottom surface inspection plate is placed on an opposite side of the transport path.

6. The method for inspecting a pouch battery cell for liquid leakage as claimed in claim 5, wherein the picking up comprises:
picking up, by the cell moving section, the pouch battery cell with a vacuum grip, the cell moving section moving the pouch battery cell above the bottom surface inspection plate;
moving, by the cell moving section, the vacuum grip downward to bring the bottom surface of the pouch battery cell into contact with the second electrolyte reaction sheet attached on the bottom surface inspection plate;
moving, by the cell moving section, the vacuum grip to an original position; and
placing, by the cell moving section using the vacuum grip, the pouch battery cell on the transport path.

7. The method for inspecting a pouch battery cell for liquid leakage as claimed in claim 4, wherein:
bringing the first electrolyte reaction sheet into contact with the top surface of the pouch battery cell and visually inspecting a change in a color of the first electrolyte reaction sheet are simultaneously performed on a plurality of pouch battery cells, and
bringing the second electrolyte reaction sheet into contact with the bottom surface of the pouch battery cell and visually inspecting a change in a color of the second electrolyte reaction sheet are simultaneously performed on the plurality of pouch battery cells.

8. An apparatus for inspecting a pouch battery cell for liquid leakage, the apparatus comprising:
a top surface inspection unit configured to bring a first electrolyte reaction sheet into contact with a top surface of a pouch battery cell and visually inspects a change in a color of the first electrolyte reaction sheet; and
a bottom surface inspection unit configured to bring a second electrolyte reaction sheet into contact with a bottom surface of the pouch battery cell and visually inspects a change in a color of the second electrolyte reaction sheet.

9. The apparatus for inspecting a pouch battery cell for liquid leakage as claimed in claim 8, wherein the top surface inspection unit comprises:
a top surface inspection plate with a bottom surface to which the first electrolyte reaction sheet is attached, the top surface inspection plate being rotatable 180° and being movable up and down; and
a top surface vision inspection section is above the top surface inspection plate to visually inspect a change in the color of the first electrolyte reaction sheet.

10. The apparatus for inspecting a pouch battery cell for liquid leakage as claimed in claim 9, wherein:
the top surface inspection plate is above a transport path, and
the pouch battery cell is below the top surface inspection plate along the transport path.

11. The apparatus for inspecting a pouch battery cell for liquid leakage as claimed in claim 10, wherein the bottom surface inspection unit comprises:
a bottom surface inspection plate with a top surface to which the second electrolyte reaction sheet is attached;
a bottom surface vision inspection section is above the bottom surface inspection plate, the bottom surface vision inspection section visually inspecting a change in the color of the second electrolyte reaction sheet; and
a cell moving section moving the pouch battery cell to the bottom surface inspection plate to bring the bottom surface of the pouch battery cell into contact with the second electrolyte reaction sheet, the cell moving section returning the pouch battery cell to an original position.

12. The apparatus for inspecting a pouch battery cell for liquid leakage as claimed in claim 11, wherein:
the pouch battery cell is along the transport path,
the cell moving section is on one side of the transport path, and
the bottom surface inspection plate is on an opposite side of the transport path.

13. The apparatus for inspecting a pouch battery cell for liquid leakage as claimed in claim 11, wherein the cell moving section comprises:
a vacuum grip for holding the pouch battery cell; and
a mover for moving the vacuum grip over the bottom surface inspection plate.

14. The apparatus for inspecting a pouch battery cell for liquid leakage as claimed in claim 11, the apparatus further comprising:
a first support on a first side of the transport path to support the top surface vision inspection section; and
a second support on a second side of the transport path to support the bottom surface vision inspection section.

15. The apparatus for inspecting a pouch battery cell for liquid leakage as claimed in claim 11, wherein:
the top surface inspection unit comprises a plurality of top surface inspection plates and a plurality of top surface vision inspection sections to simultaneously inspect the top surface on a plurality of pouch battery cells, and
the bottom surface inspection unit comprises a plurality of bottom surface inspection plates and a plurality of bottom surface vision inspection sections to simultaneously inspect the bottom surface on the plurality of pouch battery cells.
